(19) United States
(12) Patent Application Publication
(10) Pub. No.: US 2024/0236272 A9
(43) Pub. Date: Jul. 11, 2024

(54) Immersive Teleconferencing within Shared Scene Environments

(71) Applicant: Google LLC, Mountain View, CA (US)

(72) Inventor: Stéphane Hervé Loïc Hulaud, Stockholm (SE)

(21) Appl. No.: 18/484,935

(22) Filed: Oct. 11, 2023

Related U.S. Application Data
(60) Provisional application No. 63/418,309, filed on Oct. 21, 2022.

(51) Int. Cl. H04N 7/15; G06F 3/01; G06T 7/70; G06V 10/141; G06V 10/26; G06V 10/70

(52) U.S. Cl. CPC H04N 7/157; G06F 3/013; G06T 7/70; G06V 10/141; G06V 10/26; G06V 10/70; G06T 2207/10016; G06T 2207/10152; G06T 2207/20081; G06T 2207/30201

(57) ABSTRACT

Methods, systems, and apparatus are described for immersive videoconferencing teleconferencing streams from multiple endpoints within shared scene environment. The method includes receiving a plurality of streams for presentation at a teleconference, wherein each of the plurality of streams represents a participant of a respective plurality of participants of the teleconference. The method includes, determining scene data descriptive of a scene environment, the scene data comprising at least one of lighting characteristics, acoustic characteristics, or perspective characteristics of the scene environment. The method includes, for each of the plurality of participants of the teleconference, determining a position of the participant within the scene environment and, based at least in part on the scene data and the position of the participant within the scene environment, modifying the stream that represents the participant.

### PRIORITY CLAIM

The present application is based on and claims priority to U.S. Provisional Application 63/418,309 having a filing date of Oct. 21, 2022, which is incorporated by reference herein.

### FIELD

The present disclosure relates generally to immersive teleconferencing. More particularly, the present disclosure is related to teleconferencing within a shared scene environment.

### BACKGROUND

The development of teleconferencing has allowed real-time communication between different participants at different locations. Often, participants in a teleconference will utilize different types of devices to participate in the teleconference (e.g., mobile devices, tablets, laptops, dedicated teleconferencing devices, etc.). Generally, these devices each provide varying capabilities (e.g., processing power, bandwidth capacity, etc.), hardware (e.g., camera/microphone quality), connection mechanisms (e.g., dedicated application client vs. browser-based web application) and/or varying combinations of the above. Furthermore, participants in teleconferences often broadcast (e.g., audio data, video data, etc.) from varying environments. For example, one participant may broadcast from a meeting room, while another participant may broadcast from a home office. Due to these differences, broadcasts from participants in a teleconference can vary substantially.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for immersive teleconferencing within a shared scene environment. The method includes receiving, by a computing system comprising one or more computing devices, a plurality of streams for presentation at a teleconference, wherein each of the plurality of streams represents a participant of a respective plurality of participants of the teleconference. The method includes determining, by the computing system, scene data descriptive of a scene environment, the scene data comprising at least one of lighting characteristics, acoustic characteristics, or perspective characteristics of the scene environment. The method includes, for each of the plurality of participants of the teleconference, determining, by the computing system, a position of the participant within the scene environment, and, based at least in part on the scene data and the position of the participant within the scene environment, modifying, by the computing system, the stream that represents the participant,

Another example aspect of the present disclosure is directed to a computing system for immersive teleconferencing within a shared scene environment. The computing system includes one or more processors. The computing system includes one or more memory elements including instructions that when executed cause the one or more processors to receive a plurality of streams for presentation at a teleconference, wherein each of the plurality of streams represents a participant of a respective plurality of participants of the teleconference. The one or more processors are further to determine scene data descriptive of a scene environment, the scene data comprising at least one of lighting characteristics, acoustic characteristics, or perspective characteristics of the scene environment. The one or more processors are further to, for each of the plurality of participants of the teleconference, determine a position of the participant within the scene environment, and, based at least in part on the scene data and the position of the participant within the scene environment, modify the stream that represents the participant.

Another example aspect of the present disclosure is directed to A non-transitory computer readable medium that, when executed by a processor, cause the processor to receive a plurality of streams for presentation at a teleconference, wherein each of the plurality of streams represents a participant of a respective plurality of participants of the teleconference. The processor is further to determine scene data descriptive of a scene environment, the scene data comprising at least one of lighting characteristics, acoustic characteristics, or perspective characteristics of the scene environment. The processor is further to, for each of the plurality of participants of the teleconference, determine a position of the participant within the scene environment, and, based at least in part on the scene data and the position of the participant within the scene environment, modify the stream that represents the participant.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system that performs immersive teleconferencing within a shared scene environment according to example implementations of the present disclosure.

FIG. 2 illustrates an example flow chart diagram of an example method for teleconferencing with a shared scene environment, according to some implementations of the present disclosure.

FIG. 3 is a data flow diagram for immersive teleconferencing within a shared scene environment according to some implementations of the present disclosure.

FIG. 4 is data flow diagram for stream modification using machine-learned models for immersive teleconferencing within a shared scene environment according to some implementations of the present disclosure.

FIG. 5 illustrates an example interface of a teleconferencing session displaying a modified output stream that depicts a participant at a participant device, according to some embodiments of the disclosure.

FIG. 6 illustrates an example interface of a teleconferencing session that displays a shared stream that depicts multiple participants at a participant device, according to some implementations of the present disclosure.

Reference numerals that are repeated across plural figures are intended to identify the same features in various implementations.

### DETAILED DESCRIPTION

### Overview

Generally, the present disclosure is directed to teleconferencing within a shared scene environment (e.g., a virtualized scene environment, etc.) to normalize and/or provide consistency within the participants' presentations for a more immersive teleconferencing experience. Specifically, participants of a teleconference (e.g., a videoconference, audio conference, multimedia conference, etc.) often broadcast streams (e.g., streaming video data, audio data, pose data, Augmented Reality (AR)/Virtual Reality (VR) data, etc.) from a variety of environments using a variety of devices. For example, one participant in a teleconference may be a large group of people broadcasting video and audio data streams from a meeting room using a teleconferencing device (e.g., a webcam, multiple microphones, etc.). Another participant in the teleconference may call in to the teleconference with a smartphone via a Public Switched Telephone Network (PSTN) to broadcast an audio data stream. Yet another participant may broadcast a video data stream from an outdoors environment using a laptop while on vacation. However, these substantial differences in broadcasting devices and broadcasting environments can often break the immersion of teleconferencing participants, therefore reducing the quality of their teleconferencing experience.

Accordingly, implementations of the present disclosure propose immersive teleconferencing within shared scene environments. For example, a computing system (e.g., a cloud computing system, a teleconferencing server system, a teleconferencing device, etc.) can receive streams (e.g., video streams, audio streams, etc.) for presentation at a teleconference. Each of the streams can represent a participant of the teleconference. The computing system can determine scene data that describes a scene environment, such as a campfire, a meeting room, a mansion, a cathedral, etc. The scene data can include lighting characteristics, acoustic characteristics, and/or perspective characteristics of the scene environment. For example, the scene environment may be a campfire in which participants can be positioned in a circle around the campfire. The scene data can describe lighting characteristics (e.g., a single light source from the campfire at a certain intensity), acoustic characteristics (e.g., a degree of reverb, noise, background noises, etc. associated with an outdoor campfire environment), and/or perspective characteristics (e.g., a position or size of a viewpoint of the scene environment, etc.) of the campfire scene environment.

For each of the participants in the teleconference, the computing system can determine a position of the participant within the scene environment. For example, if the scene environment is an auditorium environment, a position can be determined for the participant in the back left row of the auditorium. Based on the scene data and the position of the participant, the computing system can modify the stream that represents the participant. To follow the previous example, if the stream includes audio data, and the participant is positioned in the back of the auditorium, the computing system can modify the audio stream to correspond to the participant's position within the scene environment (e.g., audio from a participant in the back of the auditorium may be quieter with less reverb, etc.). In such fashion, implementations of the present disclosure can facilitate a shared scene environment for teleconferencing, therefore reducing the loss in teleconference quality associated with a lack of immersion by participants.

Systems and methods of the present disclosure provide a number of technical effects and benefits. As one example technical effect and benefit, substantial differences in broadcasting devices and broadcasting environments can often break the immersion of teleconferencing participants, therefore reducing the quality of their teleconferencing experience. In turn, this can reduce usage of teleconferencing services and cause participants to attend in-person meetings, reducing their efficiency. However, by providing an immersive, shared scene environment in which to participate in a teleconference, implementations of the present disclosure reduce, or eliminate, the break in immersion associated with teleconferencing from different environments, therefore reducing the inefficiencies inherent to attending in-person meetings.

Automatic: As used herein, automatic, or automated, refers to actions that do not require explicit permission or instructions from users to perform. For example, an audio normalization service that performs normalization actions for audio transmissions without requiring permissions or instructions to perform the normalization actions can be considered automatic, or automated.

Broadcast: As used herein, broadcast or broadcasting refers to any real-time transmission of data (e.g., audio data, video data, AR/VR data, etc.) from a participantdevice and/or from a centralized device or system that facilitates a teleconference (e.g., a cloud computing system that provides teleconferencing services, etc.). For example, a broadcast may refer to the direct or indirect transmission of data from a participantdevice to a number of other participant devices. It should be noted that, in some implementations, broadcast or broadcasting may include the encoding and/or decoding of transmitted and/or received data. For example, a participant broadcasting video data may encode the video data using a codec. Participants receiving the broadcast may decode the video using the codec.

Participant: As used herein, a participant may refer to any user, group of users, device, and/or group of devices that participate in a live communication session in which information is exchanged (e.g., a teleconference, videoconference, etc.). More specifically, participant may be used throughout the subject specification to refer to either participant(s) or participant device(s) utilized by the participant(s) within the context of a teleconference. For example, a group of participants may refer to a group of users that participate remotely in a videoconference with their own respective devices (e.g., smartphones, laptops, wearable devices, teleconferencing devices, broadcasting devices, etc.). For another example, a participant may refer to a group of users utilizing a single computing device for participation in a teleconference (e.g., a dedicated teleconferencing device positioned within a meeting room, etc.). For another example, participant may refer to a broadcasting device (e.g., webcam, microphone, etc.) unassociated with a particular user that broadcasts data to participants of a teleconference (e.g., an audio transmission passively recording an auditorium, etc.). For yet another example, participant may refer to a bot or an automated user that participates in a teleconference to provide various services or features for other participants in the teleconference (e.g., recording data from the teleconference, providing virtual assistant services, providing testing services, etc.).

As such, it should be broadly understood that any references to a “participant” exchanging data (transmitting data, receiving data, etc.), or processing data (e.g., encoding data, decoding data, applying codec(s) to data, etc.), or in any way interacting with data, refers to a computing device utilized by one or more participants.

Additionally, as described herein, a participant may exchange information in a real-time communication session (e.g., a teleconference) via an endpoint. An endpoint can be considered a device, a virtualized device, or a number of devices that allow a participant to participate in a teleconference.

Teleconference: As used herein, a teleconference (e.g., videoconference, audioconference, media conference, Augmented Reality (AR)/Virtual Reality (VR) conference, etc.) is any communication or live exchange of data (e.g., audio data, video data, AR/VR data, etc.) between a number of participants. Specifically, as used herein, a teleconference includes the exchange of audio transmissions. For example, a teleconference may refer to a videoconference in which multiple participants utilize computing devices to transmit audio data and video data to each other in real-time. For another example, a teleconference may refer to an AR/VR conferencing service in which audio data and AR/VR data (e.g., pose data, image data, etc.)

Virtualized: As used herein, virtualized, or virtualization, refers to the process of determining or generating some type of virtual representation. For example, a virtualized scene environment may be data that describes various characteristics of a scene environment (e.g., lighting characteristics, audio characteristics, etc.). In some implementations, a virtualized scene environment may refer to a three-dimensional representation of a scene environment. For example, a virtualized scene environment may refer to a three-dimensional representation of the scene environment generated using a three-dimensional renderer that facilitates simulation of video and audio broadcasting within the three-dimensional representation.

With reference now to the Figures, example embodiments of the present disclosure will be discussed in further detail.

### Example Devices and Systems

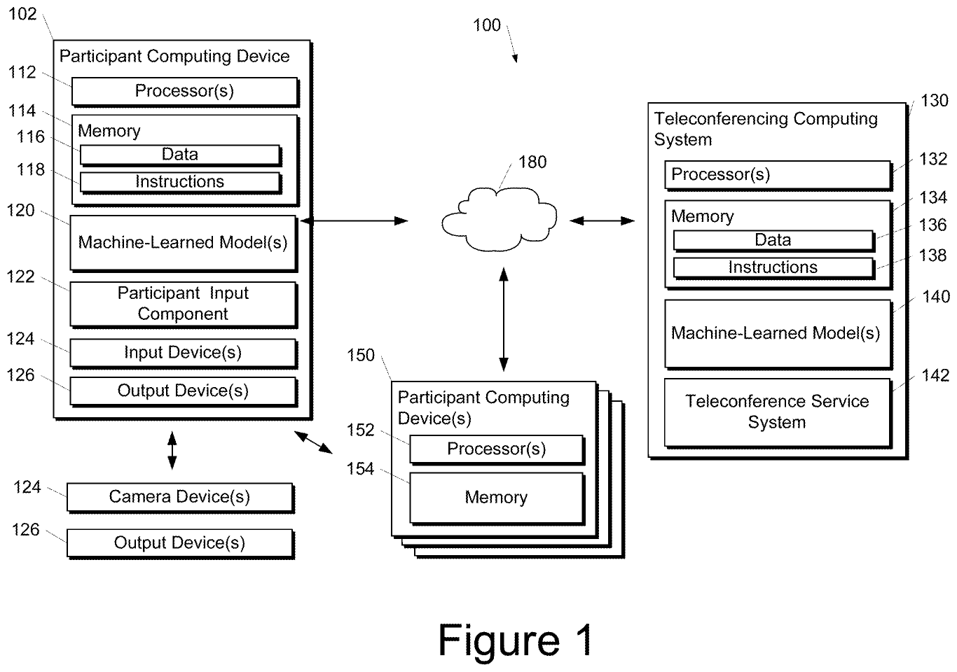

FIG. 1 depicts a block diagram of an example computing system 100 that performs immersive teleconferencing within a shared scene environment according to example implementations of the present disclosure. The system 100 includes a participant computing device 102 that is associated with a participant in a teleconference, a teleconferencing computing system 130, and, in some implementations, one or more other participant computing devices 150 respectively associated with one or more other participants in the teleconference.

The participant computing device 102 can be any type of computing device, such as, for example, a personal computing device (e.g., laptop or desktop), a mobile computing device (e.g., smartphone or tablet), a gaming console or controller, a wearable computing device (e.g., a virtual/augmented reality device, etc.), an embedded computing device, a broadcasting computing device (e.g., a webcam, etc.), or any other type of computing device.

The participant computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the participant computing device 102 to perform operations.

In some implementations, the participant computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the teleconferencing computing system 130 over network 180, stored in the participant computing device memory 114, and then used or otherwise implemented by the one or more processors 112. In some implementations, the participant computing device 102 can implement multiple parallel instances of a single machine-learned model 120 (e.g., to perform parallel modification of streams for shared scene environments across multiple instances of the machine-learned models 120).

More particularly, the machine-learned models 120 may include one or more machine-learned models. Each of the machine-learned models can be trained to process at least one of scene data, video data, audio data, pose data, and/or AR/VR data. For example, the machine-learned model(s) 120 may include a machine-learned semantic segmentation model that is trained to perform semantic segmentation tasks, such as processing video data into foreground and background components.

Additionally or alternatively, one or more machine-learned models 140 can be included in or otherwise stored and implemented by the teleconferencing computing system 130 that communicates with the participant computing device 102 according to a client-server relationship. For example, the machine-learned models 140 can be implemented by the teleconferencing computing system 130 as a portion of a web service (e.g., a shared scene environment teleconferencing service). Thus, one or more models 120 can be stored and implemented at the participant computing device 102 and/or one or more models 140 can be stored and implemented at the teleconferencing computing system 130.

The participant computing device 102 can also include one or more participant input components 122 that receives user input. For example, the participant input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example participant input components include a microphone, a traditional keyboard, or other means by which a participant can provide user input.

In some implementations, the participant computing device 102 can include, or can be communicatively coupled, input device(s) 124. For example, the input device(s) 124 may include a camera device configured to capture two-dimensional video data of a user of the participant computing device 102 (e.g., for broadcast, etc.). In some implementations, the input device(s) 124 may include a number of camera devices communicatively coupled to the participant computing device 102 that are configured to capture image data from different poses for generation of three-dimensional representations (e.g., a representation of a user of the participant computing device 102, etc.). In some implementations, the input device(s) 124 may include audio capture devices, such as microphones. In some implementations, the input device(s) 124 may include sensor devices configured to capture sensor data indicative of movements of a user of the participant computing device 102 (e.g., accelerometer(s), Global Positioning Satellite (GPS) sensor(s), gyroscope(s), infrared sensor(s), head tracking sensor(s) such as magnetic capture system(s), an omni-directional treadmill device, sensor(s) configured to track eye movements of the user, etc.).

In some implementations, the participant computing device 102 can include, or be communicatively coupled to, output device(s) 126. Output device(s) 126 can be, or otherwise include, a device configured to output audio data, image data, video data, etc. For example, the output device(s) 126 may include a two-dimensional display device (e.g., a television, projector, smartphone display device, etc.) and a corresponding audio output device (e.g., speakers, headphones, etc.). For another example, the output device(s) 126 may include display devices for an augmented reality device or virtual reality device.

The teleconferencing computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the teleconferencing computing system 130 to perform operations.

In some implementations, the teleconferencing computing system 130 includes or is otherwise implemented by one or more server computing devices. In instances in which the teleconferencing computing system 130 includes plural server computing devices, such server computing devices can operate according to sequential computing architectures, parallel computing architectures, or some combination thereof.

As described above, the teleconferencing computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

In some implementations, the teleconferencing computing system 130 can receive data of various types from the participant computing device 102 and the participant computing device(s) 150 (e.g., via the network 180, etc.). For example, in some implementations, the participant computing device 102 can capture video data, audio data, multimedia data (e.g., video data and audio data, etc.), sensor data, etc. and transmit the data to the teleconferencing computing system 130. The teleconferencing computing system 130 may receive the data (e.g., via the network 180).

As an example, the teleconferencing computing system 130 may receive a plurality of streams from participant computing devices 102 and 150. The teleconferencing computing system 130 can modify each of the streams according to scene data describing a scene environment and a participant's position within the scene (e.g., using teleconferencing service system 142, etc.). The teleconferencing computing system 130 can broadcast the streams to the participant computing devices 102 and 150.

In some implementations, the teleconferencing computing system 130 may receive data from the participant computing device(s) 102 and 150 according to various encryption scheme(s) (e.g., codec(s), lossy compression scheme(s), lossless compression scheme(s), etc.). For example, the participant computing device 102 may encode video data with a video codec, and then transmit the encoded video data to the teleconferencing computing system 130. The teleconferencing computing system 130 may decode the encoded video data with the video codec. In some implementations, the participant computing device 102 may dynamically select between a number of different codecs with varying degrees of loss based on conditions of the network 180, the participant computing device 102, and/or the teleconferencing computing system 130. For example, the participant computing device 102 may dynamically switch from video data transmission according to a lossy encoding scheme to video data transmission according to a lossless encoding scheme based on a signal strength between the participant computing device 102 and the network 180.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the teleconferencing computing system 130 may include a teleconference service system 142. The teleconference service system 142 may be configured to facilitate teleconference services for multiple participants. For example, the teleconference service system 142 may receive and broadcast data (e.g., video data, audio data, etc.) between the participant computing device 102 and participant computing device(s) 150. A teleconferencing service can be any type of application or service that receives and broadcasts data from multiple participants. For example, in some implementations, the teleconferencing service may be a videoconferencing service that receives data (e.g., audio data, video data, both audio and video data, etc.) from some participants and broadcasts the data to other participants.

As an example, the teleconference service system can provide a videoconference service to multiple participants. One of the participants can transmit audio and video data to the teleconference service system 142 using a user device (e.g., a participant computing device 102, etc.). A different participant can transmit audio data to the teleconferencing service system 142 with a participant device. The teleconference service system 142 can receive the data from the participants and broadcast the data to each participant device of the multiple participants.

As another example, the teleconference service system 142 may implement an augmented reality (AR) or virtual reality (VR) conferencing service for multiple participants. One of the participants can transmit AR/VR data sufficient to generate a three-dimensional representation of the participant to the teleconference service system 142 via a device (e.g., video data, audio data, sensor data indicative of a pose and/or movement of a participant, etc.). The teleconference service system 142 can transmit the AR/VR data to devices of the other participants. In such fashion, the teleconference service system 142 can facilitate any type or manner of teleconferencing services to multiple participants.

It should be noted that the teleconference service system 142 may facilitate the flow of data between participants (e.g., participant computing device 102, participant computing device(s) 150, etc.) in any manner that is sufficient to implement the teleconference service. In some implementations, the teleconference service system 142 may be configured to receive data from participants, decode the data, encode the data, broadcast the data to other participants, etc. For example, the teleconference service system 142 may receive encoded video data from the participant computing device 102. The teleconference service system 142 can decode the video data according to a video codec utilized by the participant computing device 102. The teleconference service system 142 can encode the video data with a video codec and broadcast the data to participant computing devices.

Additionally, or alternatively, in some implementations, the teleconference service system 142 can facilitate peer-to-peer teleconferencing services between participants. For example, in some implementations, the teleconference service system 142 may dynamically switch between provision of server-side teleconference services and facilitation of peer-to-peer teleconference services based on various factors (e.g., network load, processing load, requested quality, etc.).

The participant computing device 102 can receive data broadcast from the teleconference service system 142 of teleconferencing computing system 130 as part of a teleconferencing service (video data, audio data, etc.). In some implementations, the participant computing device 102 can upscale or downscale the data (e.g., video data) based on a role associated with the data. For example, the data may be video data may be associated with a participant of the participant computing device 102 that is assigned an active speaker role. The participant computing device 102 can upscale the video data associated with the participant in the active speaker role for display in a high-resolution display region (e.g., a region of the output device(s) 126). For another example, the video data may be associated with a participant with a non-speaker role. The participant computing device 102 can downscale the video data associated with the participant in the non-speaker role using a downscaling algorithm (e.g., lanczos filtering, Spline filtering, bilinear interpolation, bicubic interpolation, etc.) for display in a low-resolution display region. In some implementations, the roles of participants associated with video data can be signaled to computing devices (e.g., participant computing device 102, participant computing device(s) 150, etc.) by the teleconference service system 142 of the teleconferencing computing system 130.

The teleconferencing computing system 130 and the participant computing device 102 can communicate with the participant computing device(s) 150 via the network 180. The participant computing device(s) 150 can be any type of computing device(s), such as, for example, a personal computing device (e.g., laptop or desktop), a mobile computing device (e.g., smartphone or tablet), a gaming console or controller, a wearable computing device (e.g., an virtual/augmented reality device, etc.), an embedded computing device, a broadcasting computing device (e.g., a webcam, etc.), or any other type of computing device.

The participant computing device(s) 150 includes one or more processors 152 and a memory 154 as described with regards to the participant computing device 102. In some implementations, the participant computing device(s) 150 can be substantially similar to, or identical to, the participant computing device 102. Alternatively, in some implementations, the participant computing device(s) 150 may be different devices than the participant computing device 102 that can also facilitate teleconferencing with the teleconference computing system 130. For example, the participant computing device 102 may be a laptop and the participant computing device(s) 150 may be smartphone(s).

In some implementations, the input to the machine-learned model(s) (e.g., models 120, 140, etc.) can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) (e.g., models 120, 140, etc.) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) (e.g., models 120, 140, etc.) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation

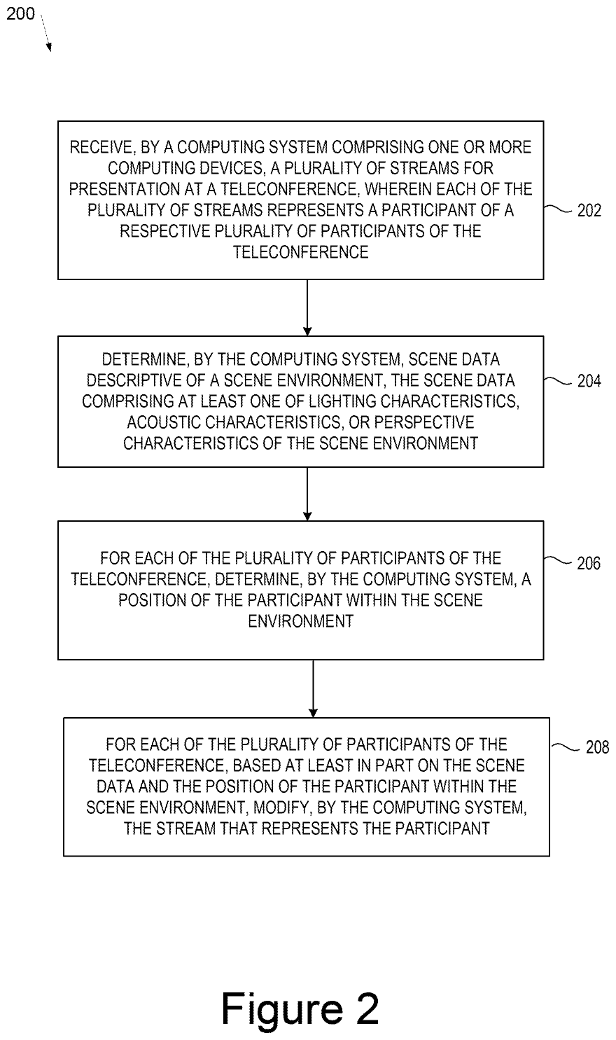

FIG. 2 illustrates an example flow chart diagram of an example method 200 for teleconferencing with a shared scene environment, according to some implementations of the present disclosure. Although FIG. 2 depicts steps performed in a particular order for purposes of illustration and discussion, the methods of the present disclosure are not limited to the particularly illustrated order or arrangement. The various steps of the method 200 can be omitted, rearranged, combined, and/or adapted in various ways without deviating from the scope of the present disclosure.

At operation 202, a computing system receives a plurality of streams for presentation at a teleconference, wherein each of the plurality of streams represents a participant of a respective plurality of participants of the teleconference.

At operation 204, the computing system determines scene data descriptive of a scene environment, the scene data comprising at least one of lighting characteristics, acoustic characteristics, or perspective characteristics of the scene environment.

At operation 206, for each of the plurality of participants of the teleconference, the computing system determines a position of the participant within the scene environment.

At operation 208, for each of the plurality of participants of the teleconference, the computing system, based at least in part on the scene data and the position of the participant within the scene environment, modifies the stream that represents the participant.

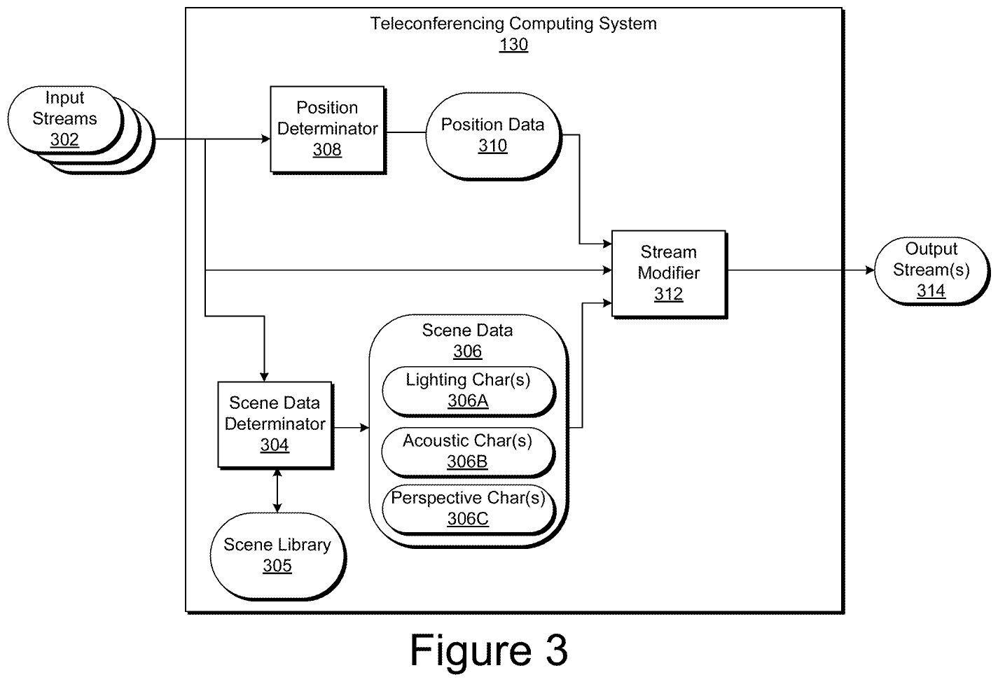

FIG. 3 is a data flow diagram for immersive teleconferencing within a shared scene environment according to some implementations of the present disclosure. Specifically, the teleconferencing computing system 130, when facilitating a teleconference, can receive input streams 302 from participants of the teleconference. In some implementations, the input streams 302 can include video data that depicts a participant. For example, an input stream 302 can depict a participant within an environment in which the participant is broadcasting (e.g., at a desk in a home office, on a plane, while walking in a city, etc.).

Additionally, or alternatively, in some implementations, the input streams 302 can include audio data corresponding to the participant. For example, the audio data of an input of stream 302 may include spoken utterances from one or more participants. For another example, the audio data of an input stream 302 may include background noise captured from an environment in which a participant is broadcasting.

Additionally, or alternatively, in some implementations, the input streams 302 can include pose data that indicates a pose of one or more participants. For example, an input stream 302 representing a participant may include two-dimensional and/or three-dimensional pose data that indicates a pose of the participant (e.g., a location and/or dimensions of various portions of a participant's body within a two-dimensional or three-dimensional space).

The teleconferencing computing system 130 can use a scene data determinator 304 to determine scene data 306 descriptive of a scene environment. The scene data 306 can describe a shared scene in which the participants broadcasting the input streams 302 can teleconference. For example, the scene data may describe a shared scene in which each participant is seated at a different seat in a conference room. For another example, the scene data may describe a shared scene in which the participants are collectively performing an activity (e.g., cycling, running, etc.). For yet another example, the scene data may describe a three-dimensional representation of a scene environment in which participants are represented in three-dimensions (e.g., via AR/VR techniques, etc.).

In some implementations, the scene data 306 can include lighting characteristics 306A. The lighting characteristics 306A for a scene can indicate source(s) of light, intensity of light, color of light, shadow(s), etc. For example, the lighting characteristics 306A for a campfire scene environment may indicate the campfire as the central and only source of light, and may indicate an intensity of the campfire and a color of the light provided by the campfire. For another example, the lighting characteristics 306A for a meeting room environment may indicate a number of ceiling lights, display device(s) (e.g., monitors, projectors, etc.), windows, hallway lights, etc. as sources of light.

In some implementations, the scene data 306 includes acoustic characteristics 306B. The acoustic characteristics 306B can indicate source(s) of audio and a type of acoustics associated with the scene environment. For example, the acoustic characteristics 306B for a campfire may indicate background noises associated with bugs, wildlife, and weather effects (e.g., rain, wind, thunder, etc.), and a type of acoustics associated with speaking outdoors (e.g., a lack of reverberation due to there being no walls to reflect sound). For another example, the acoustic characteristics 306B for an auditorium may indicate a type of acoustics associated with speaking in a large room (e.g., volume of a participant should vary based on position within a room, etc.).

In some implementations, the scene data 306 includes perspective characteristics 306C. The perspective characteristics can indicate a perspective from which the scene environment is viewed. In some implementations, the perspective characteristics 306C can indicate a single perspective from which the scene environment can be viewed. For example, if three participants are teleconferencing, and the scene environment is a campfire environment, the perspective characteristics 306C may indicate a single perspective that views the campfire such that at least a portion each of the three participants can be viewed. Alternatively, in some implementations, the perspective characteristics 306C may indicate a perspective from the scene environment can be viewed for each of the input streams 302.

In some implementations, the scene data determinator 304 can determine the scene data 306 using a scene library 305. The scene library 305 can include scene data for a number of various scenes. The scene data determinator 304 can select scene data 306 from the scene library 305 based on the input streams 302. For example, if each of the input streams 302 are streams from participants located in dark rooms, the scene data determinator 304 may select scene data 306 for a campfire scene environment from the scene library 305. For another example, if each of the input streams 302 are streams from participants located in an office environment, the scene data determinator 304 may select scene data 306 for a meeting room scene environment from the scene library 305. Alternatively, in some implementations, the scene data determinator 304 may determine scene data 306 by processing the input streams 302. For example, the scene data determinator 304 may determine that a scene environment depicted in a subset of the input streams 302 is the meeting room scene environment (e.g., a subset of participants are all broadcasting from the same meeting room). The scene data determinator 304 can determine scene data 306 that describes a prediction of the meeting room depicted in the subset of the input streams 302.

Specifically, in some implementations, the teleconferencing computing system 130 can determine a participant scene environment for each of the participants of the input streams 302 (e.g., the environment from which the depicted participant is broadcasting from). The teleconferencing computing system 130 can store the participant scene environments in the scene library 305. The teleconferencing computing system can retrieve the participant scene environments as candidate scene environments, along with other candidate scene environments and can select a candidate scene environment as the scene environment.

The input streams 302 can be processed by the teleconferencing computing system 130 with a position determinator 308 to obtain position data 310. Position data 310 can describe a position of each of the participants of the input streams 302 within the scene environment. For example, in a scene environment for an auditorium, the position data 310 can describe a position of each of the participants of the input streams 302 within the auditorium. For another example, the position data 310 may describe a three-dimensional position and/or pose at which a three-dimensional representation of a participant should be generated within a three-dimensional space (e.g., for AR/VR conferencing, etc.).

The teleconferencing computing system 130 can process the position data 310, the scene data 306, and the input streams 302 using a stream modifier 312 to obtain output streams 314. In some implementations, the output stream(s) 314 may include an output stream for each of the participants associated with the input streams 302. For example, the teleconferencing computing system 130 may receive five input streams 302 from five participants. The teleconferencing computing system 130 can output five output streams 314 using the stream modifier 312. In some implementations, when modifying the input streams 302 to obtain the output streams 314, the stream modifier 312 can modify an input stream 302 based on the positions of the participant depicted in the input streams 302 and the positions of the other participants. To follow the previously described campfire example, an output stream 314 broadcast to a first participant may depict a second participant to the first participants left and a third participant to the first participants right. An output stream broadcast to the third participant may depict the first participant to the left of the third participant and a fourth participant to the right of the third participant.

Alternatively, in some implementations, the output stream 314 can be a shared stream that includes the participants depicted by the input streams 302. For example, the input streams 302 can include video data streams that depict three participants for a campfire scene environment. The three participants can be depicted within a virtualized representation of the campfire scene environment based on the position data 310. The input streams 302 can be modified so that the participants are all positioned around the campfire in the shared output stream 314. The shared output stream 314 can then be broadcast to participant devices respectively associated with the participants. In such fashion, the teleconferencing computing system 130 can generate a shared stream that includes the input streams 302 depicted within a virtualized representation of the scene environment based on the position of the each of the participants within the scene environment.

In some implementations, to modify the input streams 302 to obtain the output stream(s) 314, the teleconferencing computing system 130 can apply a lighting correction to the input streams 302. For example, one of the input streams 302 can include video data that depicts a participant. The scene data 306 can describe or otherwise include lighting characteristics 306A for the scene environment that include a location and intensity of light source(s) within the scene environment. The teleconferencing computing system 130 can apply a lighting correction to the video data of the input stream 302 that represents the participant based at least in part on the position of the participant (e.g., as indicated by position data 310) relative to the light source(s) in the environment.

For a particular example, the environment of the participant depicted in the input stream 302 may include a single light source behind the participant, therefore causing the face of the depicted participant to be dark. The position of the participant within the scene environment, as indicated by position data 310, may be directly facing the light source(s) indicated by lighting characteristics 306A. Based on the position data 310 and lighting characteristics 306A, the teleconferencing computing system 130 can apply a lighting correction to the input stream 302 such that the face of the participant is illuminated by the light source(s) of the scene environment. It should be noted that the face, portion(s) of the body, or entities depicted in the background of the participant may all be illuminated according to the lighting characteristics 306A. For example, the scene environment indicated by the scene data 306 may be a concert environment that includes multiple sources, colors, and intensities of light. When applying the lighting correction, a high intensity blue light correction may be applied to the face of the participant while a low intensity orange light correction may be applied to a body portion of the participant (e.g., as indicated by the lighting characteristic(s) 306A). A low intensity purple light correction may be applied to a cat depicted in the background of the participant depicted in the input stream 302. In such fashion, any number or type of light source(s) can be accurately and realistically applied to all aspects of an input stream 302 to increase the immersion of the streaming experience.

In some implementations, to modify the input streams 302 to obtain the output stream(s) 314, the teleconferencing computing system 130 can apply a gaze correction to the input stream 302. For example, an input stream 302 can include video data that depicts a participant. Specifically, the video data can depict a gaze of the participant. The teleconferencing computing system 130 can determine a direction of the gaze of the participant, and determine a gaze correction for the gaze of the participant based on the position of the participant within the scene environment and the gaze of the participant (e.g., using the stream modifier 312, etc.). The teleconferencing computing system 130 can apply the gaze correction to the video data to adjust the gaze of the participant depicted in the video data of the input stream 302.

For example, the scene environment may be a campfire environment in which participants gaze at each other. The participant depicted in the input stream 302 may be positioned such that the participant is gazing to their left at a different participant (e.g., as indicated by position data 310). However, the gaze direction of the participant can be facing straight forward towards the capture device used by the participant. The teleconferencing computing system 130 can apply the gaze correction to the video data such that the participant is gazing correctly according to their position. In such fashion, the teleconferencing computing system can correct the gaze of participants to increase the immersion of the teleconference.

In some implementations, to modify the input streams 302 to obtain the output stream(s) 314, the teleconferencing computing system 130 can modify an input stream 302 for a participant to alter the acoustic characteristics of the input stream 302 to match the scene environment. For example, the input stream 302 for a participant can include audio data that corresponds to the participant. The audio data may include any type of audio or sound, such as spoken utterances from the participant and/or other participants depicted in the input stream, background noise, generated text-to-speech utterances, etc. The scene data 306 can include acoustic characteristics 306B. The acoustic characteristics 306B can indicate how sound travels within the sound environment, acoustic properties of the scene environment, a degree to which the audio data can be modified based on distance, etc. For example, if the scene environment was an auditorium environment, the acoustic characteristics 306B may indicate that reverb, echo, etc. should be applied in a manner associated with how sound travels within auditoriums. For another example, if the scene environment was a campfire environment, the acoustic characteristics 306B may indicate that the audio data should be modified in a manner associated with how sound travels in an outdoor environment. Additionally, in some implementations, the acoustic characteristics 306B may indicate, or otherwise include, background noises associated with a scene environment. For example, in the campfire scene environment, the acoustic characteristics may indicate background noises such as crickets chirping, a campfire crackling, wind blowing, etc.

The teleconferencing computing system 130 can modify the audio data based at least in part on the position of the participant within the scene environment relative to the acoustic characteristics of the stream environment. For example, if the scene environment is the auditorium environment, a participant positioned at the front of the auditorium may have different acoustics than a participant positioned at the back of the auditorium. In such fashion, the teleconferencing computing system can modify the audio data of an input stream 302 such that the audio data matches the acoustics of the scene environment, therefore increasing the immersion of the teleconference.

In some implementations, to modify the input streams 302 to obtain the output stream(s) 314, the teleconferencing computing system 130 can generate and apply a predicted rendering to a missing portion of a depicted participant. For example, the one of the input streams 302 can include video data that depicts a participant. The scene data 306 can include perspective characteristics 306C that indicate a perspective from which the scene environment is viewed. For example, the perspective characteristics 306C may indicate that the scene environment is viewed from the waist up for all participants (e.g., a meeting room scene environment in which the viewpoint of the scene is table level). To modify the input stream 302, the teleconferencing computing system 130 can determine that a portion of the participant depicted in the video data is not visible from the perspective from which the scene environment is viewed. To follow the previously described example, a camera device used to capture the participant depicted in the input stream 302 may only capture the participant from the head up. The teleconferencing computing system 130 can determine (e.g., using the stream modifier 312, etc.) that the portion of the participant between the waist and the head of the participant is visible from the perspective from which the scene environment is viewed, but is not depicted in the video data of the input stream 302.

Based on the determination, the teleconferencing computing system 130 can generate a predicted rendering of the portion of the participant not depicted in the video data of the input stream 302. For example, the teleconferencing computing system 130 (e.g., using the stream modifier 312) may process the input stream 302 with machine-learned model(s) and/or rendering tool(s) (e.g., rendering engines, three-dimensional animation tools, etc.) to generate the predicted rendering. The teleconferencing computing system 130 can apply the predicted rendering of the portion of the participant to the video data of the input stream 302 to obtain the output stream 314. In such fashion, the input stream 302 can be modified to include the predicted rendering for a missing portion of a participant, therefore increasing immersion for the teleconference.

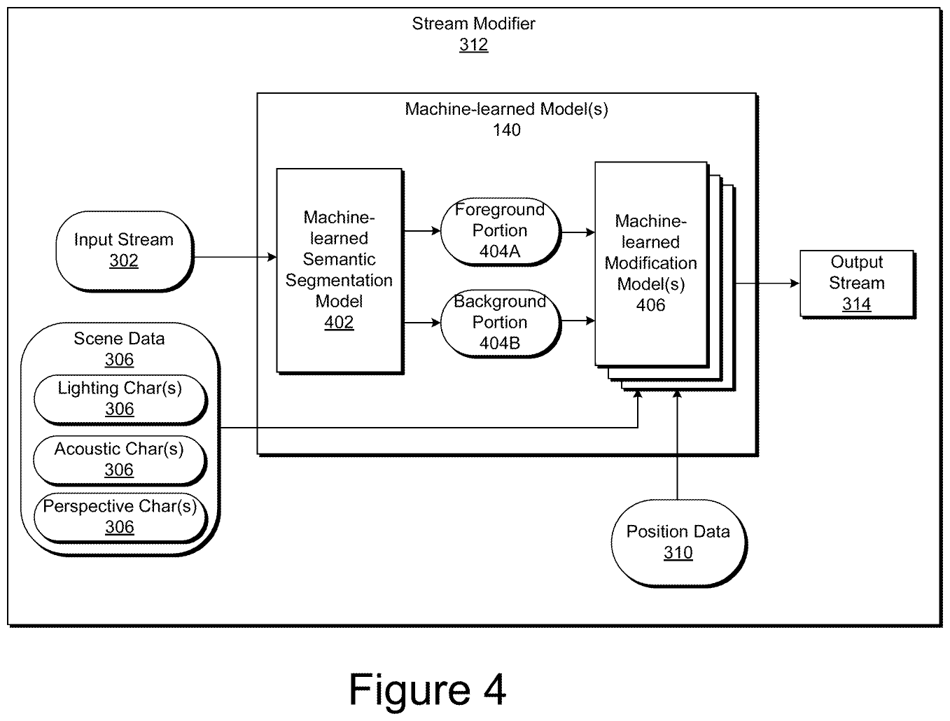

FIG. 4 is data flow diagram for stream modification using machine-learned models for immersive teleconferencing within a shared scene environment according to some implementations of the present disclosure. Specifically, the stream modifier 312 can include machine-learned model(s) 140 (e.g., machine-learned model(s) 140 of FIG. 1, etc.). The machine-learned model(s) 140 can include a number of models trained to modify the input stream 302 based on the scene data 306. For example, in some implementations, the machine-learned model(s) 140 can include a machine-learned semantic segmentation model 402. The machine-learned semantic segmentation model 402 can be trained to perform semantic segmentation tasks (e.g., semantically segmenting an input stream into a foreground and background portions, etc.). For example, the input stream 302 can include video data that depicts a participant. The machine-learned semantic segmentation model 402 can process the video data in the input stream 302 to segment the video data that represents the participant into a foreground portion 404A (e.g., a portion of video data depicting the participant and/or other entities of interest) and a background portion 404B.

In some implementations, the machine-learned model(s) 140 can include machine-learned modification model(s) 406. The machine-learned modification model(s) 406 can be trained to perform specific modifications to the input stream 302, or the foreground/background portions 404A/404B, according to certain characteristics of the scene data 306 and/or the position data 310.

For example, in some implementations, one of the machine-learned model(s) 406 (e.g., a machine-learned light correction model) may be trained to apply a light correction to an input stream 302 (e.g., as discussed with regards to FIG. 3). Additionally, or alternatively, in some implementations, one of the machine-learned model(s) 406 (e.g., a machine-learned gaze correction model) may be trained to apply a gaze correction to an input stream 302 (e.g., as discussed with regards to FIG. 3). Additionally, or alternatively, in some implementations, one of the machine-learned model(s) 406 (e.g., a machine-learned rendering model, portion prediction model, etc.) may be trained to generate a predicted rendering of a portion of a participant (e.g., as discussed with regards to FIG. 3). Additionally, or alternatively, in some implementations, one of the machine-learned model(s) 406 (e.g., a machine-learned acoustic correction model) may be trained to modify the audio data of the input stream 302 (e.g., as discussed with regards to FIG. 3). Additionally, or alternatively, in some implementations, the machine-learned model(s) 406 may be a collection of machine-learned models trained to perform the previously described modifications to the input stream 302.

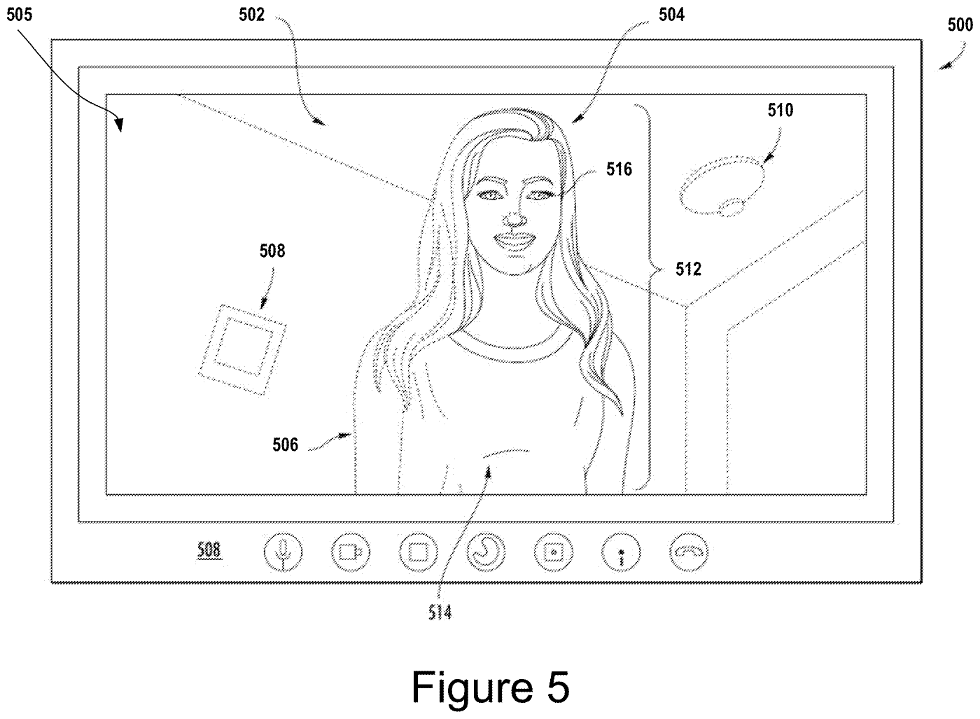

FIG. 5 illustrates an example interface of a teleconferencing session displaying a modified output stream that depicts a participant at a participant device, according to some embodiments of the disclosure. Specifically, an interface of a teleconferencing application is depicted in a display 500 receiving an output stream 502 (e.g., output stream 314 of FIGS. 3 and 4) that is broadcast from a teleconferencing service during a teleconferencing session. The output stream 502 depicts a participant 504 and a scene environment 505 in which the participant 504 is depicted. The output stream 502 received at the display 500 is modified using the described implementations of the present disclosure. For example, a portion 506 of the participant's body, a photo frame 508, and a light fixture 510 are each modified to appear as blurred. Specifically, implementations of the present disclosure can be utilized (e.g., machine-learned segmentation model 402, etc.) to separate the output stream 502 into foreground portions and background portions, and then selectively blur the background portions.

As another example, the output stream 502 may have been modified to generate a predicted rendering of a portion 514 of the participant. For example, the entirety of the participant 512 includes a portion 514 from the chest down. As described with regards to FIG. 3, the input stream from the participant 504 may only include the participant's head. Implementations of the present disclosure can be utilized to generate a predicted rendering of the portion 514 and apply the predicted rendering to the input stream to generate the entirety of the participant 512 depicted in the output stream 502.

As another example, the participant 504 depicted in the output stream 502 is depicted as having a gaze 516. The gaze 516 of the participant 504 may have been modified according to implementations of the present disclosure to align the participant's gaze 516 with the scene environment 505. For example, in an input stream to the teleconferencing service, the participant may have been depicted as having a gaze 516 with a direction to the right. Implementations of the present disclosure can be utilized to apply a gaze correction to the input stream to generate the output stream 502 in which the participant 504 is depicted with a gaze towards those viewing the display 500.

As yet another example, the scene environment 505 of the output stream 502 is depicted as having a light source 510. Lighting applied to the participant 504 may have been modified according to implementations of the present disclosure. Specifically, an input stream that depicted the participant 504 may have had a single light source behind the participant 504. Scene data that described the scene environment 505 may include light characteristics that indicate a light source positioned at the light source 510. Based on the scene data, a light correction can be applied to the right side of the face of the participant 504 to generate the output stream 502.

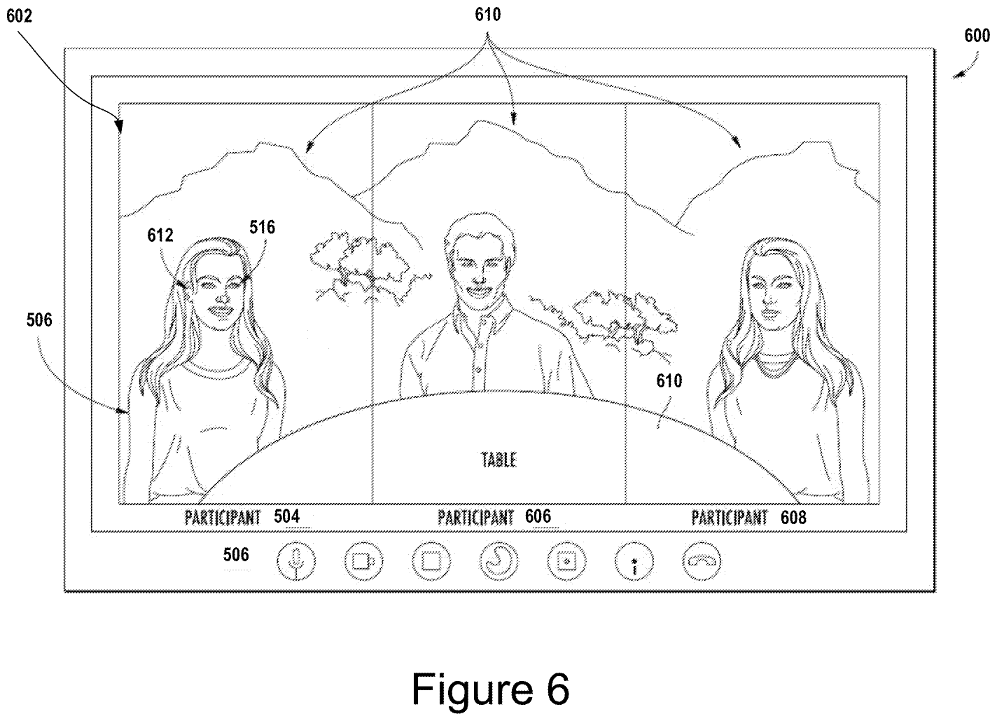

FIG. 6 illustrates an example interface of a teleconferencing session that displays a shared stream that depicts multiple participants at a participant device, according to some implementations of the present disclosure. Specifically, FIG. 6 illustrates a shared output stream 602 broadcast to a display device 600 that displays the shared output stream 602. The shared output stream 602 includes output streams that depict participants 604, 606, and 608. Specifically, the shared output stream 602 is a shared stream that includes modified streams from the participants 604-608 within a virtualized representation of a scene environment 610 (e.g., a circular meeting table scene environment with mountains in the background). The same shared stream 602 can be broadcast to participant devices of participant 604, participant 606, and participant 608. As depicted, continuous portions of the scene environment 610 are depicted across the shared output stream 602.

The shared output stream 602 received at the display 600 is modified using the described implementations of the present disclosure. For example, participant 504 (e.g., participant 504 of FIG. 5) is depicted with the same blurring effect on the portion 506. However, the ear 612 of the participant 504 has also been modified by applying a predicted rendering of the ear 612 to the participant 504 such that the participant 504 matches the depicted scene environment 610. As another example, the gaze 516 of the participant 504 has been modified via application of a gaze correction to match the position of the participant 504 within the scene environment 610 depicted in the output stream 602.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the systems and methods have been described, it should be recognized that numerous other applications are contemplated. Accordingly, other embodiments are within the scope of the following claims.

What is claimed is:

1. A computer-implemented method for immersive teleconferencing within a shared scene environment, the method comprising:
receiving, by a computing system comprising one or more computing devices, a plurality of streams for presentation at a teleconference, wherein each of the plurality of streams represents a participant of a respective plurality of participants of the teleconference;
determining, by the computing system, scene data descriptive of a scene environment, the scene data comprising at least one of lighting characteristics, acoustic characteristics, or perspective characteristics of the scene environment; and
for each of the plurality of participants of the teleconference:
determining, by the computing system, a position of the participant within the scene environment; and
based at least in part on the scene data and the position of the participant within the scene environment, modifying, by the computing system, the stream that represents the participant.

2. The computer-implemented method of claim 1, wherein the stream that represents the participant comprises at least one of:
video data that depicts the participant;
audio data that corresponds to the participant;
pose data indicative of a pose of the participant; or
Augmented Reality (AR)/Virtual Reality (VR) data indicative of a three-dimensional representation of the participant.

3. The computer-implemented method of claim 2, wherein modifying the stream that represents the participant comprises modifying, by the computing system, the stream using one or more machine-learned models, wherein each of the machine-learned models are trained to process at least one of:
scene data;
video data;
audio data;
pose data; or
AR/VR data.

4. The computer-implemented method of claim 3, wherein:
the one or more machine-learned models comprises a machine-learned semantic segmentation model trained to perform semantic segmentation tasks;
the stream that represents the participant comprises the video data that depicts the participant; and
wherein modifying the stream that represents the participant comprises segmenting, by the computing system, the video data of the stream that represents the participant into a foreground portion and a background portion using the machine-learned semantic segmentation model.

5. The computer-implemented method of claim 2, wherein:
the stream that represents the participant comprises the video data that depicts the participant;
the scene data describes the lighting characteristics of the scene environment, the lighting characteristics comprising a location and intensity of one or more light sources within the scene environment; and
wherein modifying the stream that represents the participant comprises:
based at least in part on the scene data and the position of the participant, applying, by the computing system, a lighting correction to the video data that represents the participant based at least in part on the position of the participant within the scene environment relative to the one or more light sources.

6. The computer-implemented method of claim 2, wherein:
the stream that represents the participant comprises the video data that depicts the participant, wherein the video data further depicts a gaze of the participant; and
wherein modifying the stream that represents the participant comprises:
determining, by the computing system, a direction of a gaze of the participant;
determining, by the computing system, a gaze correction for the gaze of the participant based at least in part on the position of the participant within the scene environment and the gaze of the participant; and
applying, by the computing system, the gaze correction to the video data to adjust the gaze of the participant depicted by the video data.

7. The computer-implemented method of claim 2, wherein:
the stream that represents the participant comprises the video data that depicts the participant;
the scene data comprises the perspective characteristics of the scene environment, wherein the perspective characteristics indicate a perspective from which the scene environment is viewed; and
wherein modifying the stream that represents the participant comprises:
based at least in part on the perspective characteristics and the position of the participant within the scene environment, determining, by the computing system, that a portion of the participant that is visible from the perspective from which the scene environment is viewed is not depicted in the video data;
generating, by the computing system, a predicted rendering of the portion of the participant; and
applying, by the computing system, the predicted rendering of the portion of the participant to the video data.

8. The computer-implemented method of claim 2, wherein:
the stream that represents the participant comprises the audio data that corresponds to the participant;
the scene data comprises the acoustic characteristics of the scene environment; and
wherein modifying the stream that represents the participant comprises modifying, by the computing system, the audio data based at least in part on the position of the participant within the scene environment relative to the acoustic characteristics of the scene environment.

9. The computer-implemented method of claim 1, wherein receiving the plurality of streams further comprises receiving, by the computing system for each of the plurality of streams, scene environment data for the stream descriptive of lighting characteristics, acoustic characteristics, or perspective characteristics of the participant represented by the stream; and
wherein modifying the stream that represents the participant comprises:
based at least in part on the scene data, the position of the participant within the scene environment, and the environment data for the stream, modifying, by the computing system, the stream that represents the participant.

10. The computer-implemented method of claim 1, wherein modifying the stream that represents the participant comprises:
based at least in part on the scene data, the position of the participant within the scene environment, and a position of at least one other participant of the plurality of participants within the scene environment, modifying, by the computing system, the stream that represents the participant.

11. The computer-implemented method of claim 1, wherein determining, by the computing system, the scene data descriptive of the scene environment comprises:
determining, by the computing system, a plurality of participant scene environments for the plurality of streams; and
based at least in part on the plurality of participant scene environments, selecting, by the computing system, the scene environment from a plurality of candidate scene environments.

12. The computer-implemented method of claim 11, wherein the plurality of candidate scene environments comprises at least some of the plurality of participant scene environments.

13. The computer-implemented method of claim 1, wherein:
modifying the stream that represents the participant comprises, based at least in part on the scene data and the position of the participant within the scene environment, modifying, by the computing system, the stream that represents the participant in relation to a position of an other participant of the plurality of participants; and
wherein the method further comprises broadcasting, by the computing system, the stream to a participant device respectively associated with the other participant.

14. The computer-implemented method of claim 1, wherein the method further comprises:
generating, by the computing system, a shared stream that comprises the plurality of streams depicted within a virtualized representation of the scene environment based at least in part on the position of each of the plurality of participants within the scene environment; and
broadcasting, by the computing system, the shared stream to a plurality of participant devices respectively associated with the plurality of participants.

15. A computing system for immersive teleconferencing within a shared scene environment, comprising:
one or more processors; and
one or more memory elements including instructions that when executed cause the one or more processors to:
receive a plurality of streams for presentation at a teleconference, wherein each of the plurality of streams represents a participant of a respective plurality of participants of the teleconference;
determine scene data descriptive of a scene environment, the scene data comprising at least one of lighting characteristics, acoustic characteristics, or perspective characteristics of the scene environment; and
for each of the plurality of participants of the teleconference:
determine a position of the participant within the scene environment; and
based at least in part on the scene data and the position of the participant within the scene environment, modify the stream that represents the participant.

16. The computing system of claim 15, wherein the stream that represents the participant comprises at least one of:
video data that depicts the participant;
audio data that corresponds to the participant;
pose data indicative of a pose of the participant; or
Augmented Reality (AR)/Virtual Reality (VR) data indicative of a three-dimensional representation of the participant.

17. The computing system of claim 16, wherein modifying the stream that represents the participant comprises modifying, by the computing system, the stream using one or more machine-learned models, wherein each of the machine-learned models are trained to process at least one of:
scene data;
video data;
audio data;
pose data; or
AR/VR data.

18. The computing system of claim 17, wherein:
the one or more machine-learned models comprises a machine-learned semantic segmentation model trained to perform semantic segmentation tasks;
the stream that represents the participant comprises the video data that depicts the participant; and
wherein modifying the stream that represents the participant comprises segmenting the video data of the stream that represents the participant into a foreground portion and a background portion using the machine-learned semantic segmentation model.

19. The computing system of claim 16, wherein:
the stream that represents the participant comprises the video data that depicts the participant;
the scene data describes the lighting characteristics of the scene environment, the lighting characteristics comprising a location and intensity of one or more light sources within the scene environment; and
wherein modifying the stream that represents the participant comprises:
based at least in part on the scene data and the position of the participant a lighting correction to the video data that represents the participant based at least in part on the position of the participant within the scene environment relative to the one or more light sources.

20. A non-transitory computer readable medium that, when executed by a processor, cause the processor to:
receive a plurality of streams for presentation at a teleconference, wherein each of the plurality of streams represents a participant of a respective plurality of participants of the teleconference;
determine scene data descriptive of a scene environment, the scene data comprising at least one of lighting characteristics, acoustic characteristics, or perspective characteristics of the scene environment; and
for each of the plurality of participants of the teleconference:
determine a position of the participant within the scene environment; and
based at least in part on the scene data and the position of the participant within the scene environment, modify the stream that represents the participant.
